(19) United States
(12) Patent Application Publication
(10) Pub. No.: US 2013/0018821 A1
(43) Pub. Date: Jan. 17, 2013

(54) REAL-TIME PEAK UTILITY USAGE CHARGE ASSESSMENT METHODS

(71) Applicant: VICTOR SHAO, MOUNTAIN VIEW, CA (US)

(72) Inventor: VICTOR SHAO, MOUNTAIN VIEW, CA (US)

(73) Assignee: GREEN CHARGE NETWORKS LLC, Huntington Beach, CA (US)

(21) Appl. No.: 13/549,253

(22) Filed: Jul. 13, 2012

Related U.S. Application Data
(60) Provisional application No. 61/508,525, filed on Jul. 15, 2011.

(51) Int. Cl. G06Q 30/00

(52) U.S. Cl. 705/412

(57) ABSTRACT

Some embodiments are systems which calculate the amount of electric power that a peak mitigation system provides in real time and translate that information into a real-time estimate of a peak utility usage charge that appears on the utility bill of the customer. These systems may facilitate a determination of the monetary value of demand charges saved by peak mitigation and load leveling and a notification to a customer of the savings realized. Some systems described herein provide a method of billing a customer based on the electricity usage savings accumulated through demand charge reduction procedures. One embodiment monitors the mitigation of peak loads as they occur, detects and measures incremental changes in demand charge-producing peaks and updates a projection when incremental demand charge changes occur. The demand charge projection may be presented to the customer, aggregated with demand charge projections of other sites, and displayed to increase awareness.

### CROSS REFERENCE TO RELATED APPLICATIONS

Priority is claimed to the following related pending U.S. Provisional Patent Application, which is hereby incorporated by reference in its entirety: Ser. No. 61/508,525, filed Jul. 15, 2011.

### BACKGROUND

The present invention relates to the fields of peak mitigation, load leveling charge assessment service methods, and related fields.

Commercial electric customers are commonly assessed a monthly fee called a “demand charge” that is determined by the highest power throughput recorded by a utility's billing meter during a billing cycle. These charges can result in substantial fees in some cases. For example, a customer with 50 kW of peak load during the billing period in certain parts of the United States could be assessed as much as $1,000 (or $20 per kW) per billing cycle. Despite the magnitude of demand charges, they are frequently a poorly-understood portion of customers' electricity bills, partially because the source of demand charges is not usually clearly conveyed and explained to the customer.

Even customers that have an understanding of the origin of demand charges may have difficulty in controlling the amount that appears on their bill due to what may be unpredictable electrical usage patterns. Some customers resort to installing peak mitigation and load leveling apparatus to control their incurrence of demand charges by reallocating loads to energy storage devices during peak demand periods. While a decrease in demand charges in a bill may be readily noticed by these customers after the billing period ends, real-time information about the demand charge and how it will be billed is not accessible for the customer to monitor, to track, and to keep in awareness, so demand charges may still be higher than they could be with careful monitoring and planning.

By reducing demand charges, environmentally costly infrastructure upgrades and use of highly-polluting “peaking” power plants can be decreased, but more widespread adoption of these systems is required for significant changes to occur. However, demand charge management systems may comprise sophisticated and expensive electronic equipment, and it may therefore be burdensome for customers to afford to use and maintain the batteries, power converters, computers, and other components found in them. Therefore it would be beneficial to provide methods for making demand charge management systems more affordable and for increasing awareness of demand charge calculation to the public so that more widespread adoption is a more reachable goal.

### BRIEF SUMMARY

An objective of the systems described herein is to calculate the amount of electric power that a peak mitigation procedure or apparatus provides in real time and then to translate that information into a real-time estimate of a demand charge that will appear on the bill of the customer at the end of a billing cycle. This may additionally or alternatively facilitate a determination of the monetary value of demand charges saved by peak mitigation and load leveling and a notification to a customer of the savings realized. Another objective of some systems described herein is to provide a method of billing a customer based on the electricity usage savings accumulated through demand charge reduction procedures.

Because electrical loads in a facility or site may fluctuate greatly from minute to minute or even second by second, a system embodiment described herein monitors the mitigation of peak loads as they occur, detects and measures incremental changes in demand-charge-producing peaks and updates a previously-estimated demand charge projection when incremental demand charge changes occur. The demand charge projection may be presented to the customer, aggregated with demand charge projections of other sites, and displayed to increase awareness.

In one embodiment, a method of electricity consumption management is provided, comprising: measuring power provided to a site by an energy consumption management system for an electricity consumer during a utility billing period, calculating a peak load prevented for the electricity consumer at the site during the utility billing period, determining a peak utility usage charge estimate for the site, and transmitting the peak utility usage charge estimate before the end of the utility billing period.

In some embodiments, the peak utility usage charge estimate is a demand charge estimate. In some embodiments, the peak utility usage charge estimate is determined in real-time. In some embodiments, the peak utility usage charge estimate represents a peak utility usage charge that the consumer would have been assessed if not for the power provided by the energy consumption management system. In some embodiments, the peak utility usage charge estimate represents peak utility usage charge savings due to the peak load prevented. In some embodiments, the peak utility usage charge estimate represents the peak utility usage charge that the consumer will be assessed if the metered power usage at the site does not exceed a previous metered peak load during the utility billing period. In some embodiments the peak utility usage charge estimate is transmitted to the electricity consumer or a third party. In some embodiments, the peak utility usage charge estimate is transmitted to a peak utility usage charge counter. In some of these embodiments, the peak utility usage charge counter conveys a representation of accumulated demand charge expenses avoided or peak loads reduced. In some embodiments, the method further comprises determining the peak utility usage charge assessed by the utility provider after the utility billing period ends, and transmitting the utility usage charge assessed by the utility provider.

In another embodiment, a non-transitory computer-readable storage medium is provided which has instructions encoded thereon for operating an energy consumption management system, and the instructions comprise steps of measuring power provided to a site by an energy consumption management system for an electricity consumer during a utility billing period, calculating a peak load prevented for the electricity consumer at the site during the utility billing period, determining a peak utility usage charge estimate for the site, and transmitting the peak utility usage charge estimate before the end of the utility billing period.

In some embodiments, the peak utility usage charge estimate represents peak utility usage charge savings due to the peak load prevented. In some embodiments, the peak utility usage charge estimate is transmitted to a peak utility usage charge counter. In some embodiments, the instructions further comprise determining the peak utility usage charge assessed by the utility provider after the utility billing period ends, and transmitting the peak utility usage charge assessed by the utility provider.

In yet another embodiment, a method of power management system operation is provided, comprising: providing a power management system to an electricity consumer, the power management system having capability of mitigating a load of the electricity consumer such that a first peak load is metered when a second peak load would otherwise have been metered, wherein the first peak load is less than the second peak load, and billing at least a portion of an electrical utility charge reduction at least prospectively resulting from mitigating the load.

In some embodiments, the prospective electricity charge reduction is the difference between an unmitigated electrical utility charge an a mitigated electrical utility charge, wherein the unmitigated electrical utility charge would be billable to the electricity consumer based on the second peak load if the second peak load had not been mitigated, and wherein the mitigated electrical utility charge is billable to the electricity consumer based on the first peak load if the metered load does not exceed the first peak load. In some embodiments, the portion of the difference billed to the electricity consumer is at least partially proportional to the magnitude of the difference between the unmitigated electrical utility charge and the mitigated electrical utility charge. In some embodiments, the electrical utility charge is a demand charge. In some embodiments, the electrical utility charge reduction is a reduction in demand charges billed by a utility provider. In some embodiments, the power management system is rented or leased. In some embodiments, the electricity consumer is billed based on the electrical utility charge reduction at least prospectively existing when the power management system rental or lease ends. In some embodiments, the power management system is rented or leased from an electrical utility provider.

Additional and alternative features, advantages, and embodiments of the invention will be set forth in the description which follows, and in part will be obvious from the description, or may be learned by the practice of the invention. The features and advantages of the invention may be realized and obtained by means of the instruments, steps, and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In addition to the novel features and advantages mentioned above, other objects and advantages of the present invention will be readily apparent from the following descriptions of the drawings and exemplary embodiments.

FIG. 1 is a flowchart outlining a process for monitoring demand charge estimates in real time.

FIG. 2 is an exemplary load profile with peak mitigation and peak loads prevented indicated.

FIG. 3 is a flowchart showing a process for assessing fees based on demand charge savings resulting from usage of a power management system.

FIG. 4 is a flowchart showing a process for assessing fees based on the demand charge savings resulting from the usage of a power management system during a lease or rental period.

### DETAILED DESCRIPTION

The detailed description set forth below in connection with the appended drawings is intended as a description of the presently preferred embodiments of systems and methods provided in accordance with aspects of the present invention and is not intended to represent the only forms in which the present invention may be constructed or utilized. The description sets forth the features and steps for making and using the test systems and methods of the present invention in connection with the illustrated embodiments. It is to be understood, however, that the same or equivalent functions and structures may be accomplished by different embodiments that are also intended to be encompassed within the spirit and scope of the invention.

Peak mitigation is a process by which demand charges may be diminished by shaving the magnitude of short peaks or spikes in a location's electrical utility consumption. A peak mitigation apparatus may be used by discharging energy storage into the location's electrical system or by reallocating loads from the site's electrical system to energy storage devices or another independent power source to prevent the power consumption recorded by the site's utility billing meter from exceeding a maximum value. If stored energy is spent, it may then be recharged during off-peak periods to regain the energy discharged in preparation for the next peak demand event.

Such energy storage devices are frequently comprised of batteries of many types, but may also comprise capacitors, flywheels, and comparable energy storage devices that may be used to store and discharge power on demand, and the energy storage devices are typically connected to the site's electrical system via inverters, DC-DC converters, or other power converters to adapt the stored energy into a useable form for the site's systems and loads.

Complications may arise when peaks are too frequent (meaning they exceed the maximum demand threshold too often), or are too high (meaning they exceed the maximum demand threshold by too much at once), consuming a great deal of power over a period of time. For example, if consumption exceeds the threshold limit over which the energy storage devices enter a mitigation/discharge mode for too long, the energy storage may become depleted and unable to mitigate. At that point, the threshold limit increases to the highest level recorded by the utility meter that will result in a demand charge to the consumer. Therefore, from that point on during that particular billing period, the threshold limit remains at that elevated level unless it must be elevated again due to energy storage depletion, because no matter how energy is managed from that point on during the billing cycle, the demand charge will be based on that elevated level. However, at the end of the billing period, and thus the start of a new billing period, the threshold limit resets and the cycle starts over again from a low threshold limit.

In addition to demand charges being affected by depletion of energy storage devices over prolonged peak periods, the magnitude of a peak may have a direct effect on the demand charge produced. For example, when a particularly high peak load is experienced by the system, the power converter or inverter may not be able to convert power quickly enough to respond without an increase in the baseline peak load limit. An inverter rated for a maximum of fifty kilowatts of power transfer is unable to convert power from the energy storage to mitigate a peak that is higher than fifty kilowatts above the threshold limit, so the threshold limit increases as the peak is not completely mitigated to remain below the threshold limit. Even if a power converter can support unlimited energy transfer rates, a very high peak quickly depletes available energy storage, leading to inability of the management system to respond to a peak. Similarly, on-site generation devices have limited output ability that can be exceeded when peaks are too high or the power management system is poorly designed. Therefore the peak load experienced by the utility meter during a billing period increases over time, along with the demand charge.

Load leveling is a process by which loads at a site are evened out over a given time period. The power management systems employed in load leveling are essentially the same as those used in peak mitigation but are usually higher-capacity and do not need to respond to fast changes in consumption. This is typically the case because whereas peak mitigation is designed to eliminate short peaks in consumption, load leveling is designed to eliminate “peaks” that may last for hours at a time, and then recharge for hours at a time. Such systems include load leveling for summer months, where if loads throughout the day and night can be leveled off, drastic electricity usage savings can be realized because the daytime energy billing rates may be much higher than the nighttime billing rates. Peak mitigation and load leveling are therefore both implemented with similar goals in mind—to reduce consumption at inopportune times, such as when demand charges will be incurred.

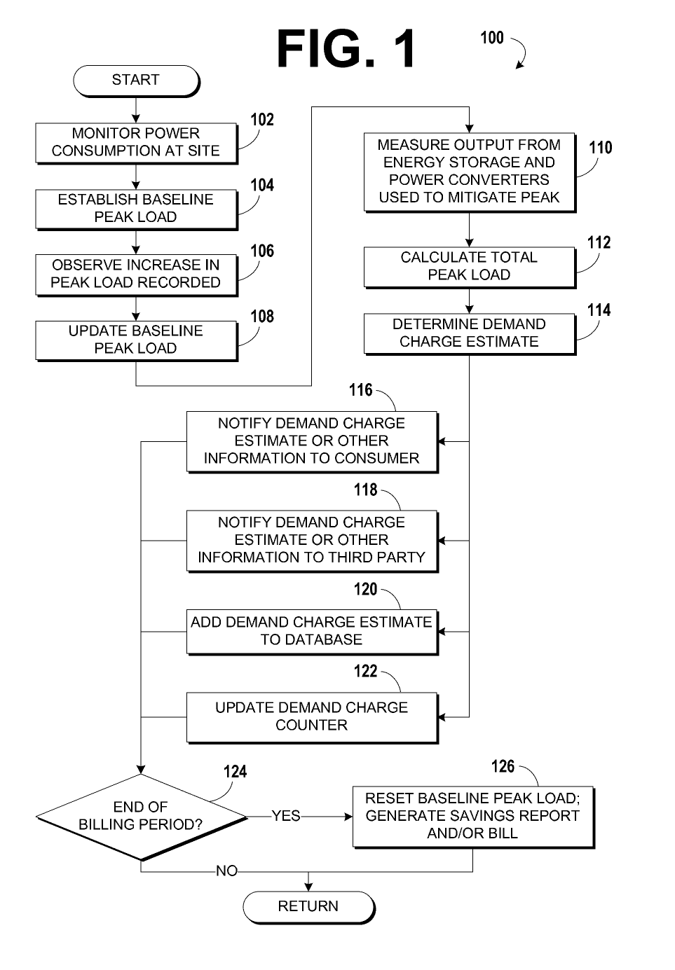

By monitoring the activity of a power management system, demand charges may be accurately predicted in real-time as the peak demand and threshold consumption limit change over the course of a billing period. FIG. 1 is a flowchart of an exemplary method by which real-time peaks and demand charges may be calculated and used. The process 100 begins at step 102 by monitoring power consumption at a site. This may be performed by a computer or system controller that may receive current and voltage sensor signals from loads, from the service panels in the site, or from the utility meter of the site itself and calculate the rate of present power consumption. The power consumption is compared to a threshold limit, i.e., baseline peak load, to determine when a peak condition occurs. The system also tracks the maximum consumption statistics measured by the utility meter and the output of the energy storage or generation devices during peak periods.

While monitoring power consumption at the site, a baseline peak load is established in step 104. The baseline peak load is the threshold limit over which a “peak” mode is entered. The baseline peak load may be a predetermined power transfer rate based on historical conditions and capacity and capability of the energy storage and power converters of the power management system. For instance, in some cases it may be advantageous to set the baseline peak load to the mean power consumption level that the site has experienced over a preceding billing period because it is likely that an energy storage device in the management system will have roughly as much time and ability to recharge while loads are below the mean as it has time and ability to discharge as loads peak above the mean if the mean of the current billing period is roughly the same and there is not significant deviation from the mean. If the baseline peak load is set too low, the energy storage device will be depleted frequently early on in the billing period and this may lead to peaks that raise the demand charge, but otherwise would not have done so if the energy storage was not prematurely depleted. If the baseline peak load is too high, demand charges will be incurred that would otherwise be avoidable if the power management system was working at mitigating the peaks, but the not peaks are not mitigated because the peak mitigation mode is not entered at a low enough consumption rate. As a billing period progresses, the baseline peak load is carried over from previous incremental increases in the baseline peak load that occur when the peak load recorded by the utility meter increases. The baseline peak load may be set at levels other than the mean if the user desires, such as setting it to an elevated or diminished level if an upcoming billing period is expected to have higher or lower peaks, respectively, as may be predicted from historical data, weather data leading to greater electricity usage, manual override, or changes to the electrical systems or energy consumption management system.

Thus, in time the system may detect an increase in peak load recorded at the utility meter, as shown in step 106, meaning the demand charge will be increased to be based on that increased peak load level until the end of the billing cycle. The baseline peak load is updated in step 108 if and/or when the peak load recorded increases. From that point on, a new definition of “peak” consumption conditions is defined, as the consumption must now exceed the higher baseline peak load value (as updated in step 108) to incur a greater demand charge, so the system does not need to mitigate loads until overall consumption surpasses the new higher baseline peak load value. In many cases, however, the baseline peak load will not increase due to energy consumption management system mitigation.

As the power management system operates to mitigate the peak experienced, the process includes a step 110 of measuring the output from the energy storage, generation, and power converters of the management system that are used to mitigate the peak. The output information from these electronics may be used to determine the magnitude of a peak that was mitigated by a power management system by determining the maximum sum of the rate of energy transfer from the power management system and the rate of energy consumption recorded by the utility provider during the peak period.

Next, the total peak load is calculated in step 112. The total peak load according to this step is the peak loading that would have been registered by the utility meter if the peak had not been mitigated by a power management system. The total peak load must be calculated because the utility meter does not register the maximum power used by the site when mitigation takes place, so the peak consumption may not be read by accessing that meter alone. To calculate the total peak load, the system may read the peak load registered at the utility meter and adds the peak output of the energy storage or generation at that time to the meter-registered peak. The highest value of the sum of those two factors that would result in a demand charge is the total peak load. Alternatively, the system may monitor the sum of the output of the power management system and the meter-recorded consumption and determine the highest value of the sum to calculate the total peak load. The total peak load may also be calculated by placing consumption-measuring sensors on each load at the site that contributes to a demand charge, then summing up the total consumption of those loads over time and selecting the highest total consumption point over a period of time. Other similar methods may be employed to determine the total peak load as well.

In some embodiments, an instantaneous or short peak in the sum of the meter-recorded consumption and the output of the management system would not be considered the total peak load unless that sum exceeded the previous total peak load for a given length of time used by the utility provider in determining demand charges. For example, if a demand charge is calculated by a utility provider as a sliding average load determined over fifteen minutes at a time, then the total peak load would be calculated as the peak in this sliding average rather than an instantaneous peak sum.

A demand charge estimate is determined at 114. The demand charge estimate is calculated using the prevailing demand charge billing rates for the site. The demand charge estimate may contain more than one number, such as, for example, a case where the demand charge estimate includes an estimate of the demand charge that would result from the baseline peak load of the site (if it remains constant) and the demand charge that would have resulted if there had been no peak mitigation. The result of step 114 is described as an estimate because the actual, billed demand charge may be greater than the value estimated by the end of the billing period if the baseline peak load increases, so the demand charge estimate is a prediction of the demand charge that would result if the baseline peak load did not increase by the end of the billing cycle.

The exact procedure for determining the monetary values in the demand charge estimate varies depending on the method that the utility provider uses to calculate demand charges, but, for example, it may be calculated in some cases by simply multiplying the total peak load (e.g., in kilowatts (kW)) by a demand charge factor (e.g., in dollars/kilowatt). Some utility providers use more complex calculations, such as a graduated system where a demand charge factor increases in a tiered fashion as the highest peak load increases, and these other methods may be used to calculate a demand charge estimate in step 114 as well, and these calculations (or approximations thereof) are included in the determination.

Following the determination of the demand charge estimate, four options may be executed or presented to the user. For instance, the next step may be to notify the demand charge estimate to a consumer of electricity at 116 or to notify a third party regarding the change in the demand charge estimate at 118. Embodiments that notify a consumer or third party may do so by presenting demand charge information on a visual display, audio speaker, radio frequency signal, or other means for conveying information to the designated target recipient. It may be beneficial to notify the consumer regarding the demand charge estimate so that the consumer may detect and respond to changes before the demand charge increases too much to be manageable. It may also allow the consumer to identify loads that contribute inordinately to the peak load so that they can reduce usage in future demand charge billing periods. Third parties, such as a utility company, may find it useful to be notified of the demand charge estimate to more easily anticipate future peak loads, demand charge bills and income, and for general observation and safety monitoring. Other third parties, including the power management system operator, seller, or power management service provider may receive demand charge estimates for various reasons as well.

In some cases, the power management system may be financed and/or paid for based on the amount of demand charge savings that the consumer realizes, so the demand charge estimate may be used to calculate bills to the consumer when provided with other information such as the total peak load. This method of billing the customer based on their demand charge savings realized enables a business model where instead of buying the power management system equipment up front, the customer pays for the equipment or the services provided thereby according to the benefit they receive. The quantification of demand charge savings establishes a proper accounting of value provided and thus enables a rental or lease-based business model for the power management systems based on the savings which may be bundled with maintenance of the systems and other services with mutual benefit. More information regarding these business models will be given hereinafter.

The demand charge estimate may also be added to a database at 120 or used to update a demand charge counter at 122. A database in step 120 may include a repository of consumption information, such as, for example, a computer data bank that tracks consumption, demand charges, and other information for data analysis in order to more appropriately establish a baseline peak load and to provide recommendations to the consumer or a third party regarding power management system sizing requirements, typical peak loading conditions, variation in consumption and demand over long periods of time, and other data for improvement and optimization of the power management systems.

A demand charge counter in step 122 is a display provided by a consumer or third party to show how use of a power management system reduces demand charges and peak consumption. For example, a demand charge counter may include a visual element that displays an ever-increasing tally or number that counts up the demand charge expenses avoided and/or peak loads reduced. The demand charge counter may be placed in a website as a user graphical interface element or may be an analog or digital display, such as an LCD screen or physical dial or meter that shows information about demand charges and other information to the viewer in a user-readable format. The number indicated on the demand charge counter is determined by gathering one or more demand charge estimates and obtaining the rate at which the demand charge is expected to accumulate over the remainder of the billing period, and then increasing the number on the counter at the same rate as the demand charge's expected increase. At times the counter may need to be adjusted, such as when the demand charge estimate increases during the billing period, since the anticipated savings for that billing period will have to be proportionally reduced to account for the discrepancy in demand charge estimates to remain accurate. When an adjustment takes place, the counter may be reduced by a portion of the value of the difference between the new and old demand charge estimates that corresponds to the time for which the old demand charge estimate was inaccurate. A demand charge counter may be used to quantify the return on investment (ROI) made for a one or more power management systems and raises awareness of their value as it is constantly refreshed to what is potentially an ever-higher number.

After at least one of steps 116, 118, 120, and 122 is completed, the system process controller checks to see if the billing period has ended at 124. If it has not, the process restarts, but if the billing period has ended, the baseline peak load is reset to the default level at step 126 before restarting the process. (Alternatively, the process 100 may simply end.) The final baseline peak load for the site before the billing period ended may also be transferred to a database and reported or used in a bill to improve the quality of the algorithm for determining the default baseline peak load and for renting or financing the power management system itself.

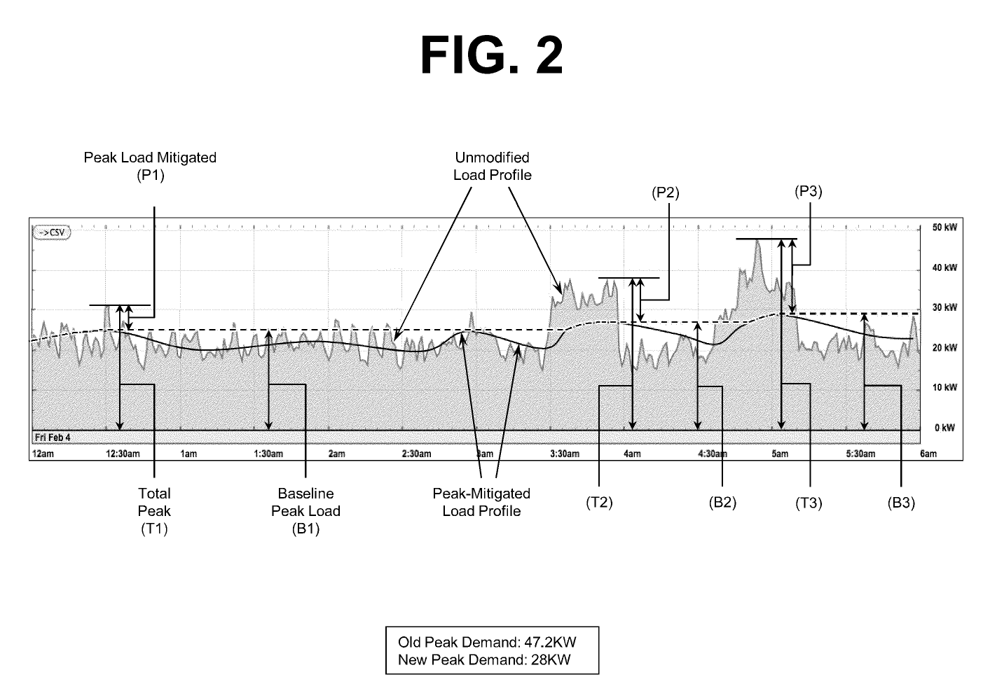

FIG. 2 is graph showing a sample unmodified load profile and a peak-mitigated load profile where an energy storage-enabled power management system is implemented. The peak-mitigated load profile is the profile of consumption recorded by the utility meter at this site. An unmodified load profile is shown with varying degrees of peaks and valleys in consumption over time. The peak-mitigated load profile shows the consumption profile that is recorded at the utility meter as time progresses. When the unmodified load profile is higher than the peak-mitigated load profile, the power management system is supplying power to the site to reduce the load to reach the peak-mitigated load profile. The peak-mitigated load profile may at points be shown to be higher than valleys in the unmodified load profile because, at least in this embodiment, the power management system draws power from the site to recharge its energy storage device.

The baseline peak load (e.g., B1, B2, or B3) is the peak value that the meter has recorded up until a new baseline peak load is reached, as shown by the fact that each baseline peak load is the highest value that the peak-mitigated load profile has reached as time progresses. Therefore, the final baseline peak load of a billing period is the value that the utility provider would use to determine the demand charge at the end of the billing period, and the baseline peak load is reset to a default value, such as zero kilowatts, after the billing period ends and a new one begins.

The total peak (e.g., T1, T2, or T3) is the sum of the present baseline peak load (e.g., B1, B2, or B3) and the peak load prevented (e.g., P1, P2, or P3). The peak load prevented may be determined by either calculating the total peak and reducing that value by the baseline peak load or by measuring the point where the peak-mitigated load profile plus the output of the power management system has the highest magnitude.

As shown in FIG. 2, the baseline peak load increases as time passes. Typically the baseline peak load increases when an extended peak period occurs, such as the transitions from B1 to B2 and B2 to B3, since the energy storage of the power management system is more likely to deplete or to be unable to handle the difference in the magnitude of the peak over the baseline peak load, thereby being unable to reduce the unmodified load profile without increasing the baseline peak load.

A real-time estimate of the demand charge that the customer of FIG. 2 will be assessed can be determined. This is because the baseline peak load is the value that the electric power company will use to determine the demand charge, and as time progresses, the baseline peak load increases in line with the expected demand charge amount.

The real-time estimation of the demand charge enables methods of billing customers for demand charge savings at times other than at the end of a billing cycle, providing increased flexibility in payment structures for financed or rented power management systems to the seller of those systems and for the customer. These customers would otherwise not be aware of the time that these demand charges are being accrued because they only receive notification of the charge at the end of a billing cycle. A real-time monitoring and alert system increases demand charge awareness, and may provide warning to the customer so that preventative action can be taken to keep the demand charges from increasing unpredictably.

In some embodiments these methods may enable a business model of renting or leasing a portable power management system for a limited time, such as a few hours, a day, several days, weeks, months, or more, while collecting at least a portion of the rental fees based on the demand charge savings that the renting or leasing customer realizes during the rental or lease term. If a site such as a sporting arena, hotel, event center, or household is expected to have much greater than usual consumption for a limited time, a portable, disconnectable power management system may be installed to prevent an excessive demand charge, and the rental fee for the system may be directly linked to the demand charges avoided by having the system active during that time. This allows the power management system provider to bill a customer based on the difference between the maximum demand charge that would have or could have been incurred by the total peak load and the demand charge that is or at least potentially will be incurred by the mitigated peak load prevented. Alternatively, the provider may charge a fee proportional to the magnitude of this difference, a fee that is equal to the value of the demand charge savings realized up to a limit, or another advantageous charging scheme. A fee that is proportional to the savings realized (or prospectively realized, if the fee is assessed before the actual demand charge is assessed by the utility provider) reduces the cost of ownership of the power management system over time and provides more active notification of the demand charges avoided by the consumer. This billing format also encourages power management system providers to provide power management systems to electricity customers that will benefit from the systems the most, since they would likewise be rewarded the most.

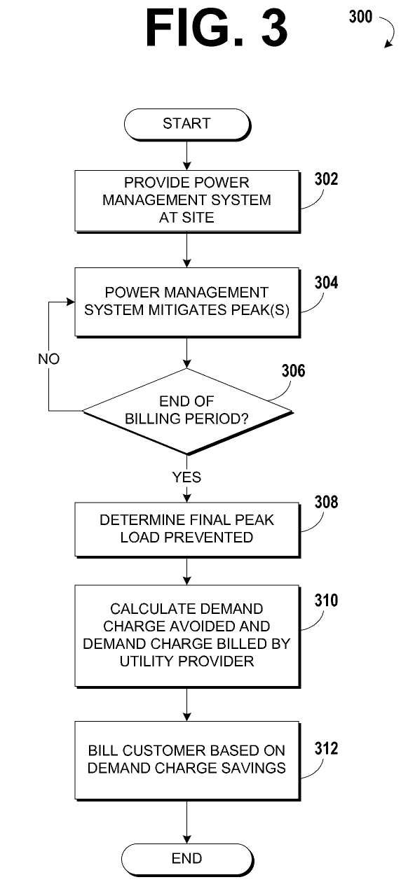

FIG. 3 shows a flowchart outlining a method 300 by which a customer may be billed for demand charges saved by use of a power management system. A power management system is provided or installed (at 302) at a site and it mitigates peaks in consumption (at 304). When the billing period ends (at 306), the final peak load prevented is determined (at 308). The final peak load prevented is preferably used because earlier peak loads prevented, if any, may be misleading in showing the beneficial reduction in demand charges if the baseline peak load increases toward the end of the billing period. Then the demand charge billed by the utility provider is compared to the demand charge avoided by use of the power management system (at 310), and the customer is billed based on the savings realized (at 312). The power management system of this method may be purchased by the customer and financed, at least in part, by the bills of step 312, or the power management system may be leased for a limited time or indefinitely and the leasing and/or maintenance fees may be at least partially fulfilled by the bills of step 312. In another embodiment, the final peak load prevented determined in step 308 comprises the peak load prevented at the time that the power management system is removed from the site. This embodiment allows the demand charge savings provided to be accounted for in a billing agreement even though a final assessment of demand charge by the utility provider has not been given. This embodiment may be particularly useful in arrangements where the power management system is provided for a limited time, perhaps a duration of days or weeks that are shorter than a complete billing cycle for the utility provider, since the demand charge aversion provided during that limited time can be determined without having to wait to the end of a billing cycle to see whether the system's operation had the desired effect.

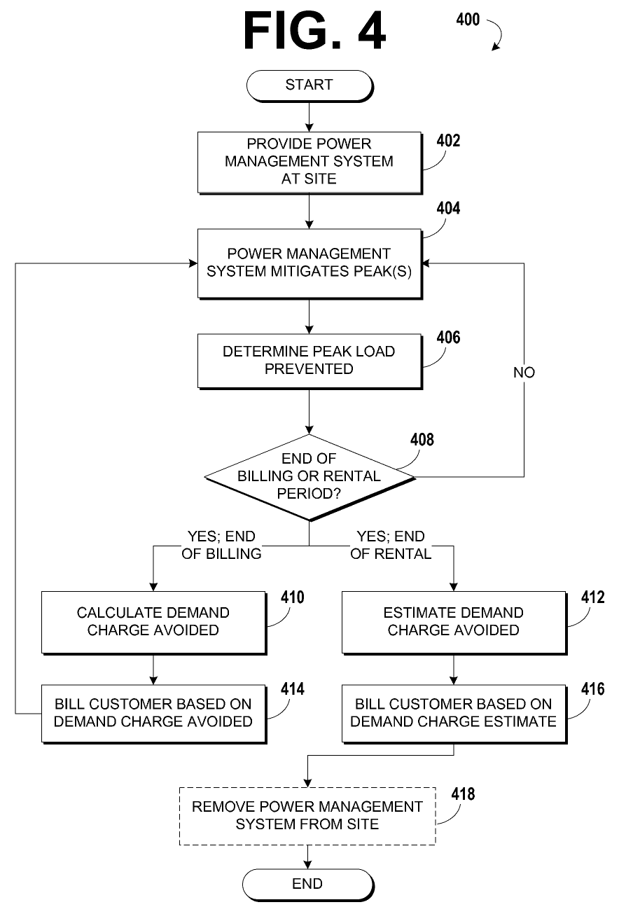

FIG. 4 shows a flowchart of a method 400 by which a customer may be billed for demand charges saved by rental of a power management system. A power management system may be provided at a site (at 402), and the power management system mitigates one or more peaks in consumption (at 404). The system keeps track of the peak load prevented when a peak is mitigated, as shown in 406. Once the system determines that the end of a demand charge billing period is reached at 408, the demand charge avoided is calculated using the peak load prevented at 410, and the customer is billed based on the demand charge avoided at 414 as the power management system resumes mitigating peaks at 404. When the end of the rental period is reached at 408, any peak loads prevented before the end of the billing period are converted into an estimated demand charge avoided at 412 and the customer is billed a rental fee based on the demand charge estimate at 416. The power management system may then be removed from the site at 418, if necessary, and the rental process is terminated or the process may restart.

The rental or leasing fee for use of the power management system may be determined by standard equipment rental procedures in the art in some embodiments, but due to the monitoring features and sensors of the power management system a rental fee may also be based on the demand charge assessed, or based on the savings realized from avoiding a demand charge, without having to wait for the end of a billing period to know the fee that the electric company would require for a demand charge. In these cases, a demand charge estimate is calculated based on the difference between the baseline peak load and the total peak (e.g., P2 or P3 in FIG. 2) and the demand charge billing rates for the site.

The fees collected during the rental or lease of a power management system may be assessed differently depending on the embodiment implemented and the agreement between the customer and the power management system provider. For example, the fees may be proportional to the demand charge savings, may follow a function of the demand charge savings, may be dependent on the demand charge savings surpassing a predetermined lower or upper limit (e.g., demand charge savings must surpass $0.00, $100.00, or $1,000.00 or must be below $1,000.00 or some other number for a rental fee to result), may rely on the present price of electricity or the price of a demand charge, combinations of these methods, and other similar methods. The rental or leasing fee may be assessed after the billing period that included a rental period has passed, but it may also be assessed beforehand, such as at the time the power management system rental period ends, since the power management system may determine the demand charge for a site that would have occurred if there had not been a peak mitigation apparatus present.

Alternative demand charge billing schedules may also be possible to implement at the site where a power management system is deployed, such as charging the customer based on demand charge savings over half of (or some other division of) a billing period. In this case, the customer may be charged based on estimated demand savings at a first interval, then charged on the actual demand savings at a second interval when the utility's demand charge billing period ends. Any over- or under-payment of the fee portion of the overall savings may be accounted for in the second payment. This configuration may be preferable in order to keep incremental bills lower and to raise awareness of the demand charges being assessed over time.

Some methods and systems of the embodiments of the invention disclosed herein may also be embodied as a computer-readable medium containing instructions to complete those methods or implement those systems. The term “computer-readable medium” as used herein includes not only a single physical medium or single type of medium, but also a combination of one or more tangible physical media and/or types of media. Examples of a computer-readable medium include, but are not limited to, one or more memory chips, hard drives, optical discs (such as CDs or DVDs), magnetic discs, and magnetic tape drives. A computer-readable medium may be considered part of a larger device or it may be itself removable from the device. For example, a commonly-used computer-readable medium is a universal serial bus (USB) memory stick that interfaces with a USB port of a device. A computer-readable medium may store computer-readable instructions (e.g. software) and/or computer-readable data (i.e., information that may or may not be executable). In the present example, a computer-readable medium (such as memory) may be included to store instructions for the management system or a billing system to determine peak loads prevented, detect billing period information, notify or bill a customer, or perform other actions and processes disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In addition, it should be understood that the figures described above, which highlight the functionality and advantages of the present invention, are presented for example purposes only and not for limitation. The exemplary architecture of the present invention is sufficiently flexible and configurable, such that it may be utilized in ways other than that shown in the figures. It will be apparent to one of skill in the art how alternative functional, logical or physical partitioning, and configurations can be implemented to implement the desired features of the present invention. Also, a multitude of different constituent module or step names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in multiple various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments. The invention is also defined in the following claims.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “typical,” “conventional,” “traditional,” “normal,” “standard,” “known” and terms of similar meaning should not be construed as limiting the time described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise or context dictates otherwise. Similarly, a group of items linked with the conjunction “or” should not be read as requiring mutual exclusivity among that group, but rather should also be read as “and/or” unless expressly stated or context dictates otherwise. Furthermore, although items, elements or component of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Further, the purpose of the Abstract is to enable the U.S. Patent and Trademark Office and the public generally, and especially the scientists, engineers, and practitioners in the art who are not familiar with patent or legal terms or phraseology to determine quickly from a cursory inspection the nature and essence of the technical disclosure of the application. The Abstract is not intended to be limiting as to the scope of the present invention in any way.

What is claimed is:

1. A method of electricity consumption management, comprising:
measuring power provided to a site by an energy consumption management system for an electricity consumer during a utility billing period;
calculating a peak load prevented for the electricity consumer at the site during the utility billing period;
determining a peak utility usage charge estimate for the site; and
transmitting the peak utility usage charge estimate before the end of the utility billing period.

2. The method of claim 1, wherein the peak utility usage charge estimate is a demand charge estimate.

3. The method of claim 1, wherein the peak utility usage charge estimate is determined in real-time.

4. The method of claim 1, wherein the peak utility usage charge estimate represents a peak utility usage charge that the consumer would have been assessed if not for the power provided by the energy consumption management system.

5. The method of claim 1, wherein the peak utility usage charge estimate represents peak utility usage charge savings due to the peak load prevented.

6. The method of claim 1, wherein the peak utility usage charge estimate represents the peak utility usage charge that the consumer will be assessed if the metered power usage at the site does not exceed a previous metered peak load during the utility billing period.

7. The method of claim 1, wherein the peak utility usage charge estimate is transmitted to the electricity consumer or a third party.

8. The method of claim 1, wherein the peak utility usage charge estimate is transmitted to a peak utility usage charge counter.

9. The method of claim 8, wherein the peak utility usage charge counter conveys a representation of accumulated demand charge expenses avoided or peak loads reduced.

10. The method of claim 1, further comprising:
determining the peak utility usage charge assessed by the utility provider after the utility billing period ends; and
transmitting the peak utility usage charge assessed by the utility provider.

11. A non-transitory computer-readable storage medium having instructions encoded thereon for operating an energy consumption management system, the instructions comprising steps of:
measuring power provided to a site by an energy consumption management system for an electricity consumer during a utility billing period;
calculating a peak load prevented for the electricity consumer at the site during the utility billing period;
determining a peak utility usage charge estimate for the site; and
transmitting the peak utility usage charge estimate before the end of the utility billing period.

12. The non-transitory computer-readable storage medium of claim 11, wherein the peak utility usage charge estimate represents peak utility usage charge savings due to the peak load prevented.

13. The non-transitory computer readable storage medium of claim 11, wherein the peak utility usage charge estimate is transmitted to a peak utility usage charge counter.

14. The non-transitory computer-readable storage medium of claim 11, the instructions further comprising:
determining the peak utility usage charge assessed by the utility provider after the utility billing period ends; and
transmitting the peak utility usage charge assessed by the utility provider.

15. A method of power management system operation, comprising:
providing a power management system to an electricity consumer, the power management system having capability of mitigating a load of the electricity consumer such that a first peak load is metered when a second peak load would otherwise have been metered, wherein the first peak load is less than the second peak load; and
billing at least a portion of an electrical utility charge reduction at least prospectively resulting from mitigating the load.

16. The method of claim 15, wherein the prospective electrical utility charge reduction is the difference between an unmitigated electrical utility charge and a mitigated electrical utility charge, wherein the unmitigated electrical utility charge would be billable to the electricity consumer based on the second peak load if the second peak load had not been mitigated, and wherein the mitigated electrical utility charge is billable to the electricity consumer based on the first peak load if the metered load does not exceed the first peak load.

17. The method of claim 16, wherein the portion of the difference billed to the electricity consumer is at least partially proportional to the magnitude of the difference between the unmitigated electrical utility charge and the mitigated electrical utility charge.

18. The method of claim 16, wherein the electrical utility charge is a demand charge.

19. The method of claim 15, wherein the electrical utility charge reduction is a reduction in demand charges billed by a utility provider.

20. The method of claim 15, wherein the power management system is rented or leased.

21. The method of claim 20, wherein the electricity consumer is billed based on the electrical utility charge reduction at least prospectively existing when the power management system rental or lease ends.

22. The method of claim 20, wherein the power management system is rented or leased from an electrical utility provider.
